(19) United States
(12) Patent Application Publication
(10) Pub. No.: US 2018/0063577 A1
(43) Pub. Date: Mar. 1, 2018

(54) DISTRIBUTION DEVICE, DISTRIBUTION SYSTEM, DISTRIBUTION METHOD, ELECTRONIC MACHINE, PLAY DEVICE AND RECEIVING PROGRAM

(71) Applicant: Smart Mobile Broadcasting Technology, Inc., Taipei (TW)

(72) Inventor: Toshimi MORIZUMI, Taipei (TW)

(21) Appl. No.: 15/674,956

(22) Filed: Aug. 11, 2017

(30) Foreign Application Priority Data
Aug. 26, 2016 (TW) 105127406

(51) Int. Cl. H04N 21/4405; H04N 21/835; H04N 21/433

(52) U.S. Cl. CPC H04N 21/4405; H04L 65/607; H04N 21/433; H04N 21/835

(57) ABSTRACT

A distribution system comprises a play device 1, a distribution device 2 and an electronic machine 3 to function as a content distribution system. The distribution device 2 receives content signals and authorization information ECM (entitlement control message) from a play wave. Afterward, the distribution device 2 distributes the content signals and authorization information ECM to the electronic machine 3 by a communication means and in the same format as play wave transmission. A content protection disabling portion 30 of the electronic machine 3 is capable of performing content protection processing on content signals and simplifying the structure of the electronic machine 3, regardless of whether the content signals are transmitted from the play device 1 by a play wave or distributed from the distribution device 2 by a communication means.

### RELATED APPLICATIONS

This application claims priority to Taiwan Application Serial Number 105127406, filed on Aug. 26, 2016, which is incorporated by reference herein in its entirety.

### BACKGROUND OF THE INVENTION

### Field of the Invention

The present invention relates to a distribution device, a distribution system, a distribution method and a play device for distributing encoded content signals and an electronic machine and a receiving program for receiving encoded content signals.

### Background

In the past, content signals are transmitted by a play wave as well as receiving and reproducing content signals by an electronic machine, such as a TV set. Moreover, in the recent years, content signals are generally transmitted by a communication means as well as receiving and reproducing content signals by an electronic machine.

The service providers encode content signals and then transmit the encoded content signals so that a user which signs a contract can access the content in an audiovisual manner. The received electronic machine end has to decode the encoded content signals.

### CITATION DOCUMENT

### Patent Document

[Patent Document 1] Japanese Unexamined Patent Application Publication No. 2010-178176

### SUMMARY OF THE INVENTION

### Problem to be Solved by the Invention

In general, an encoding process associated with the transmission of content signals by a play wave is different from an encoding process associated with the transmission of content signals by a communication means. An electronic machine thus requires a functional portion for decoding play wave encoded content signals and a functional portion for decoding communication means encoded content signals. As a result, the electronic machine is so structurally complicated that it incurs high manufacturing costs and high power consumption.

In view of the aforesaid problems, the objective of the present invention is to provide an electronic machine and a receiving program for decoding encoded content signals by a simple structure. Moreover, yet another objective of the present invention is to provide a distribution device, a distribution system, a distribution method and a play device which distribute encoded content signals to the electronic machine.

### Problem-Solving Means

The present invention provides, in an aspect thereof, a content distribution system which comprises a play device (1), a distribution device (2), and an electronic machine (3). The content distribution system is characterized in that: the electronic machine (3) has an inherent first key (Km); the play device (1) has a fourth key (Km), second key (Ks), and third key (Kw) which correspond to the first key of the electronic machine; the play device (1) comprises: a first encoding portion (121) for encoding content signals with the second key (Ks) to generate encoded content signals, wherein the content signals contain control information required for distribution of content by a play wave; a second encoding portion (122) for encoding the second key (Ks) and content information (the content information is for use in determining whether the content signals can be decoded) with the third key (Kw) to generate a first authorization information (entitlement control message, ECM); a third encoding portion (123) for encoding the third key (Kw) and contract information of the electronic machine with the fourth key (Km) to generate a second authorization information (EMM, entitlement management message); a first transmitting portion (124) for transmitting the encoded content signals and the first authorization information (ECM) by a play wave; and a second transmitting portion (125) for transmitting by a communication means the second authorization information (EMM) to the electronic machine having the first key (Km); the distribution device (2) comprises: a first receiving portion (21) for receiving the encoded content signals and the first authorization information (ECM) from the play device; a processing portion (22) for replacing at least a portion of the control information in the encoded content signals with a specified value, compressing the encoded content signals which are processed by the replacement and storing in a storing portion (23), and storing the first authorization information (ECM) in the storing portion (23); and a distributing portion (24) for determining whether to transmit the stored content signals to the electronic machine at the electronic machine's request in accordance with the first authorization information and distributing the stored content signals and the first authorization information (ECM) to the electronic machine by a communication means when the determination is affirmative; the specified value is adapted to increase a compression rate or equals 0. The electronic machine (3) comprises: a second receiving portion (31a) for receiving from a play wave the encoded content signals and the first authorization information (ECM) which are transmitted from the play device; a third receiving portion (31b) for receiving from a communication means the second authorization information (EMM) which is transmitted from the play device; a first decoding portion (321) for decoding the second authorization information (EMM) with the first key (Km) of the electronic machine and recovering the contract information and the third key (Kw); a second decoding portion (322) for decoding the first authorization information (ECM) with the decoded third key (Kw) and recovering the second key (Ks) and the content information; a contract determining portion (324) for determining whether to decode the encoded content signals in accordance with the content information and the contract information; a third decoding portion (33) for decoding the encoded content signals with the recovered second key (Ks) when determining to decode the encoded content signals; and further comprises a communication portion (36) which requests the distribution device to transmit content signals and receives from the communication means the encoded content signals and the first authorization information which are transmitted from the distribution device. The second decoding portion (322) decodes both the first authorization information (ECM) received by the second receiving portion (31a) and the first authorization information (ECM) received by the communication portion (36). The contract determining portion (324) determines whether to decode the content signals received by the second receiving portion (31a) and the content signals received by the communication portion (36). The third decoding portion (33) decodes both the content signals received by the second receiving portion (31a) and the content signals received by the communication portion (36).

Given the aforesaid structure, with encoded content signals being received by the distribution device from a play wave, content signals adapted for use with a play wave and thus encoded can be distributed to the electronic machine. Moreover, the electronic machine not only processes content signals received from a play wave but also processes content signals received from a communication means, and thus its structure is simplified.

The present invention provides, in an embodiment thereof, a distribution device, characterized in that comprising: a receiving portion for receiving from a play wave encoded content signals and authorization information for decoding the encoded content signals; a processing portion for storing the received content signals and authorization information in a storing portion; and a distributing portion for distributing the stored content signals and authorization information by a communication means at the electronic machine's request.

Given the aforesaid structure, with encoded content signals being received from a play wave, content signals adapted for use with a play wave and thus encoded can be distributed to the electronic machine.

The encoded content signals may further contain control information required for play wave-based transmission, and the processing portion may replaces at least a portion of the control information in the encoded content signals with a specified value and compresses the encoded content signals which is processed by the replacement. At this point in time, the specified value is adapted to increase a compression rate or equals 0.

Given the aforesaid structure, the compression rate can be increased by replacing control information.

Moreover, the distributing portion determines, in accordance with the authorization information, whether to transmit at the electronic machine's request the requested content signals to the electronic machine and, when the determination is affirmative, distributes the content signals. Given the aforesaid structure, the electronic machine which the content signals must be distributed to can be appropriately determined.

Moreover, the processing portion can also correct the authorization information so that the corrected authorization information is stored in the storing portion. The distributing portion determines in accordance with the corrected authorization information whether to transmit the requested content signals to the electronic machine.

The present invention provides in an embodiment thereof an electronic machine, comprising: a receiving portion for receiving encoded content signals from a play wave; a contract determining portion for determining whether to decode the encoded content signals; a decoding portion for decoding the encoded content signals when the determination is affirmative; and a communication portion for receiving encoded content signals from a communication means. The contract determining portion determines whether to decode the content signals received by the receiving portion and the content signals received by the communication portion. The decoding portion decodes the content signals received by the receiving portion and the content signals received by the communication portion.

Given the aforesaid structure, the structure of the electronic machine is simplified, because both the content signals received from a play wave and the content signals received from a communication means are processed.

The present invention provides, in an embodiment thereof, a distribution system, comprising: a play device for transmitting encoded content signals by a play wave; the distribution device; and the electronic machine.

The present invention provides, in an embodiment thereof, a distribution method comprising: a step of receiving from a play wave encoded content signals and authorization information for decoding the encoded content signals; a step of storing the received content signals and authorization information in a storing portion; and a step of distributing the stored content signals and authorization information by a communication means at an electronic machine's request.

The present invention provides a receiving program executable by a computer to perform: a step of receiving encoded content signals from a play wave; a step of receiving encoded content signals from a communication means; a step of determining whether to decode content signals received by the play wave or content signals received by the communication means; and a step of decoding the encoded content signals when the determination is affirmative.

The present invention provides a play device, comprising: a play distributing portion for transmitting, by a play means, a first signal which constitutes a content signal; and a communication distributing portion for distributing, by a communication means, a second signal which constitutes the content signal, wherein the first signal and the second signal have the same format and can be decoded by one decoding portion, wherein the first signal and the second signal are transmitted synchronously.

Given the aforesaid structure, since the first signal and the second signal can be decoded by one decoding portion, a machine structure for receiving the signals can be simplified.

The play device comprises: an encoding portion for encoding the content signals; and a content separating portion for separating the encoded content signals into the first signal and the second signal.

Given the aforesaid structure, the first signal and second signal can be in the same format, because content signals are encoded by one encoding portion.

The present invention provides, in an embodiment thereof, an electronic machine, comprising: a receiving portion for receiving from a play means a first signal encoded by an encoding portion and adapted to constitute a content signal; a communication portion for receiving from a communication means a second signal encoded by the encoding portion, adapted to constitute the content signal, and transmitted in synchrony with the first signal; a content integration portion for integrating the first signal and the second signal; and a decoding portion for decoding the encoded first signal, the encoded second signal, and/or the integrated signal.

Given the aforesaid structure, the structure of the electronic machine is simplified, because one decoding portion generates a first signal, a second signal and an integrated signal.

Moreover, the present invention provides, in an embodiment thereof, a distribution system which comprises the play device and the electronic machine.

Moreover, the present invention provides, in an embodiment thereof, a receiving program executable by a computer to perform: a step of receiving from a play means a first signal encoded by an encoding portion and adapted to constitute a content signal; a step of receiving from a communication means a second signal encoded by the encoding portion, adapted to constitute the content signal, and transmitted in synchrony with the first signal; a step of integrate the first signal and the second signal; and a step of decoding any one of the encoded first signal, the encoded second signal and the integrated signal by a decoding means.

### Effect of the Invention

The present invention features a simple structure conducive to the decoding of encoded content signals.

### BRIEF DESCRIPTION OF THE DRAWINGS

FIG. 1 is a schematic view of a content distribution system according to the first embodiment of the present invention;

FIG. 2 is a schematic view of a relationship between a “product” and “content” for use with the content distribution system;

FIG. 3 is a block diagram of constituent elements of devices of FIG. 1;

FIG. 4 is a schematic view of customer information attributed to customers and stored in a customer information memory portion 11;

FIG. 5 is a block diagram of a content protection processing portion 12;

FIG. 6 is a schematic view of content information;

FIG. 7 is a schematic view of contract information;

FIG. 8 is a schematic view of operation of a processing portion 22;

FIG. 9 is another schematic view of operation of the processing portion 22;

FIG. 10 is a block diagram of an electronic machine 3;

FIG. 11 is a flow chart of operation of the content distribution system;

FIG. 12 is a block diagram of devices in the content distribution system according to a comparative example of the present invention; and

FIG. 13 is a schematic view of the content distribution system according to the second embodiment of the present invention.

### DETAILED DESCRIPTION OF THE EMBODIMENTS

The embodiment of the present invention is hereunder illustrated by drawings and described in detail.

### First Embodiment

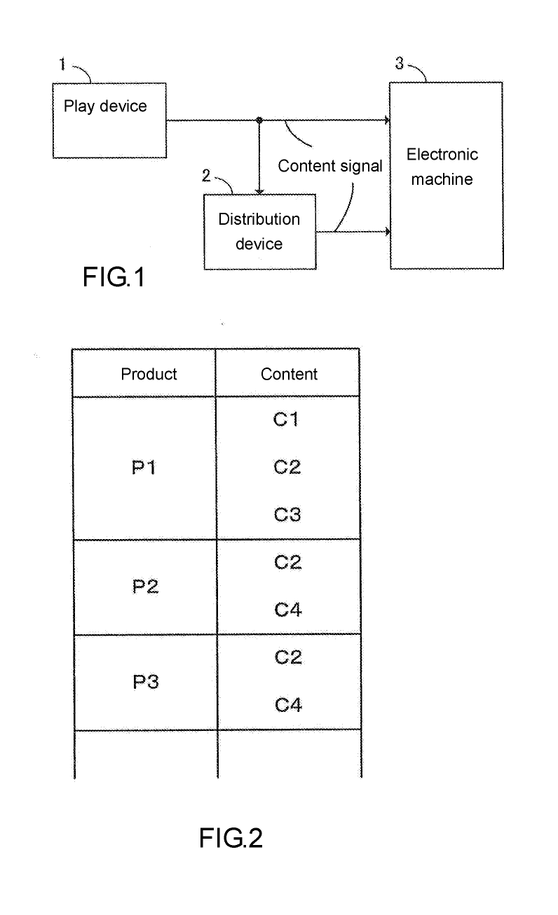

FIG. 1 is a schematic view of a content distribution system according to the first embodiment of the present invention. The content distribution system comprises a play device 1, a distribution device 2, and an electronic machine 3. Although FIG. 1 shows one electronic machine 3, the content distribution system usually comprises a plurality of electronic machines 3. The play device 1 transmits encoded content signals to the electronic machine 3 by a play wave. The distribution device 2 transmits encoded content signals to the electronic machine 3 by a communication means.

The content signals relate to news, movies, drama, and musical series, but the present invention is not limited thereto. Moreover, the content signals usually include video signals and audio signals, but it does not matter if the content signals include only one of the video signals and the audio signals.

Moreover, content signals contain control information, such as program specific information (PSI) and service information (SI). PSI is required for reproducing and playing content. SI is required for playing content and includes content and a title of the content. The control information is necessary when transmitting content signals from the play device 1 by a play wave and receiving and reproducing by the electronic machine 3. However, no control information is required for distributing content signals from the distribution device 2 by the communication means and reproducing content signals by the electronic machine 3.

The play device 1 is, for example, disposed in a play radio station where the content signals are encoded and thereby protected before being transmitted by a play wave.

The distribution device 2 receives content signals from a play wave transmitted by the play device 1 and then stores the content signals therein. Afterward, the distribution device 2 distributes to the electronic machine 3 by the communication means the content signals requested by a user through the electronic machine 3.

The electronic machine 3 is a smartphone, a tablet terminal, a personal computer, or a TV set, and is a receiver used by the user. The electronic machine 3 receives content signals from a play wave transmitted by the play device 1. The electronic machine 3 can reproduce the currently played content instantly. For expediency's sake, the aforesaid way of distributing content by a play wave and reproducing the content is known as instant play service. The play device 1 and the electronic machine 3 will suffice, provided that the instant play service is offered.

By requesting the distribution device 2, the electronic machine 3 receives from the communication means the content signals stored in the distribution device 2. The electronic machine 3 can reproduce content wanted by the user at the time wanted by the user. For expediency's sake, the aforesaid way of distributing content by the communication means and reproducing the content is known as video on demand (VoD) service. The play device 1, the distribution device 2 and the electronic machine 3 are required for accessing the VoD service.

The instant play service and the VoD service are offered by the same service provider or by different service providers.

This embodiment is substantially identical to the preceding one except that this embodiment requires various functional portions of the electronic machine 3 designed for instant play service dedicated to play service and thus is still for use in VoD service provided through the communication means.

To access the instant play service and the VoD service in the content distribution system, the user has to sign a contract with each service provider and purchase product for use in audiovisual content.

FIG. 2 is a schematic view of a relationship between a “product” and “content” for use with the content distribution system. The products are “units” purchased by the user with the electronic machine 3, wherein one product correlates with one content or a plurality of contents.

For instance, FIG. 2 shows that contents C1˜C3 are associated with product P1. The user who purchased product P1 can access contents C1˜C3 in an audiovisual manner. By contrast, the user needs to purchase just product P1 in order to access all or part of contents C1˜C3 in an audiovisual manner. For instance, the contents C1˜C3 are the first through third episodes of a drama and thus are correlated; alternatively, the contents C1˜C3 are not correlated.

Moreover, FIG. 2 shows that content C2 is associated with both product P1 and product P2; alternatively, such a content may also be associated with a plurality of products. To access content C2 in an audiovisual manner, the user purchases either product P1 or product P2.

Moreover, FIG. 2 shows that products belong to product P3 and product belong to product P2 are identical products. However, contents C2, C4 can be accessed in an audiovisual manner by just using instant play service with product P2 or using either instant play service or VoD service with product P3. It is feasible to preconfigure that product P3 is more expensive than product P2.

Products are configured in accordance with type of content, quantity of content, service offered, fees, and duration of audiovisual access, thereby offering to the user more choices and enhancing ease of use.

The information related to the aforesaid product is transmitted from the play device 1 to the electronic machine 3 by a play wave or a communication means. The electronic machine 3 displays the information related to the product so that users can purchase any products with the electronic machine 3. The information displayed on the electronic machine 3 not only discerns users and products purchased by the users, respectively, but is also regarded as customer information and recorded in the play device 1 (to be described later.) Moreover, the electronic machine 3 not only stores the displayed information pertaining to purchased products but also regards the information as contract information (to be described later.)

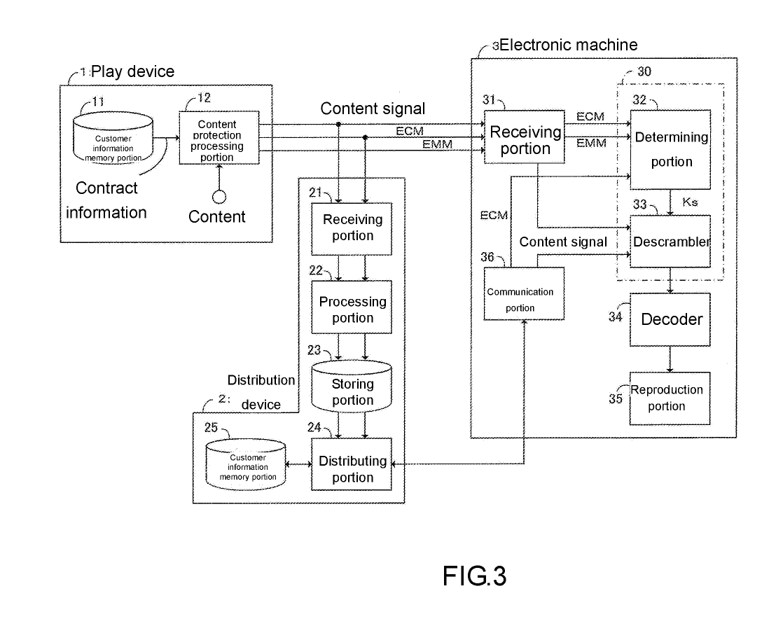

FIG. 3 is a block diagram of constituent elements of devices of FIG. 1. The internal structures of the play device 1, the distribution device 2 and the electronic machine 3 are described below in sequence.
The play device 1 comprises a customer information memory portion 11 and a content protection processing portion 12.

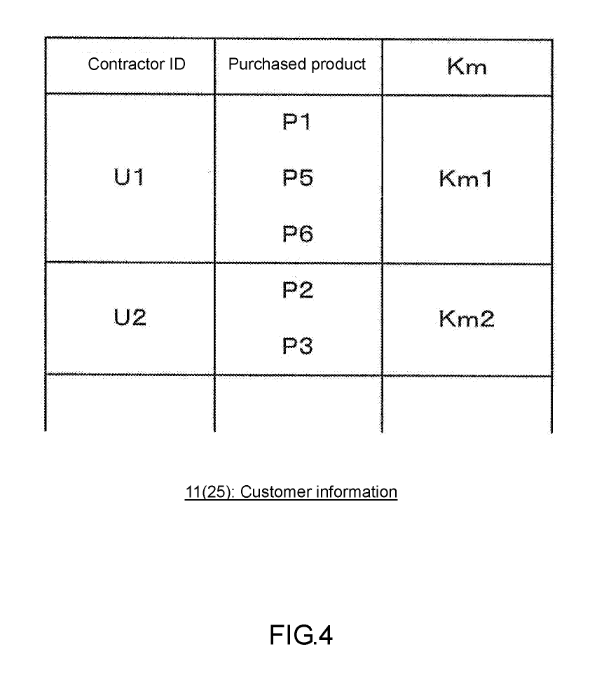

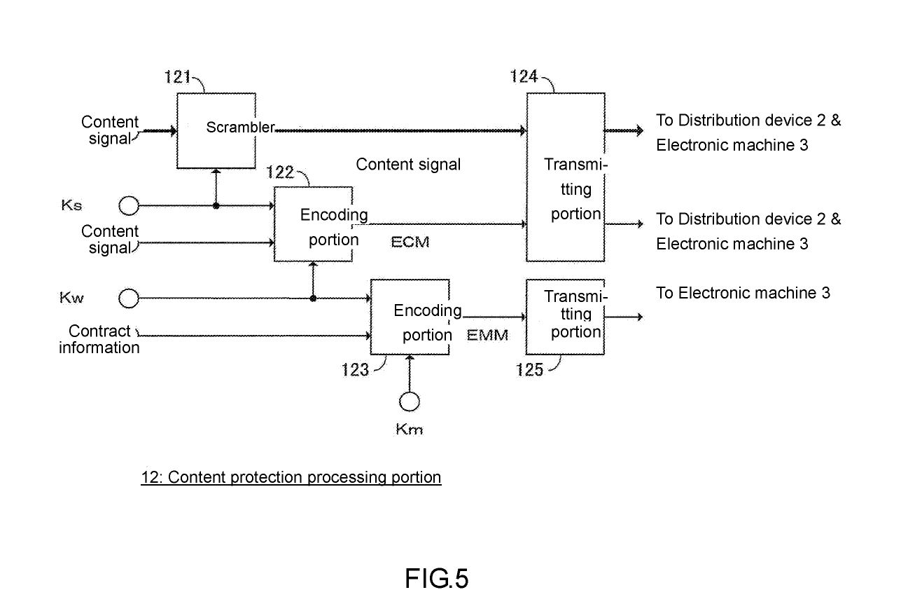

FIG. 4 is a schematic view of customer information attributed to customers and stored in the customer information memory portion 11. The customer information relates to contractors who sign contracts with the content distribution system. More specifically, the customer information serves to correlate a specific contractor's ID (contractor ID), products purchased by each contractor (purchased products), and each contractor's inherent key Km (main key, first key) with each other and is stored. The contractor ID is, for example, inherent information pertaining to the electronic machine 3 being used by the user or any user ID. The key Km is assigned to each contractor. The electronic machines 3 each have the inherent key Km. The play device 1 has different keys Km (i.e., the fourth key corresponding to the first key) corresponding in quantity to the contractors.

Referring to FIG. 3, the content protection processing portion 12 fetches content from a content provider. Afterward, the content protection processing portion 12 effectuates protection processing in the course of transmission of content signals to the distribution device 2 and the electronic machine 3 to avoid reproducing content signals to any third party other than the contractor. Moreover, the content protection processing portion 12 uses the aforesaid contract information and specified key to generate the authorization information for decoding the encoded content signals. The content protection processing portion 12 is further described below.

FIG. 5 is a block diagram of the content protection processing portion 12. The content protection processing portion 12 has a scrambler (first encoding portion) 121, encoding portions (the second and third encoding portions) 122, 123, and transmitting portions 124, 125. The content protection processing portion 12 can also be a single device or comprises a plurality of devices. Moreover, constituent elements of the content protection processing portion 12 may provided in the form of hardware. Alternatively, the content protection processing portion 12 may has a built-in processor for executing a content protection processing program (not shown), whereas at least a portion of the content protection processing portion 12 is effectuated by software.

The scrambler 121 uses the key Ks (scramble key, second key) to perform a scramble process on content signals. The content signals are encoded to enter a state in which decoding does not occur without the key Ks. The key Ks is in the possession of the content protection processing portion 12, it is not different in accordance with different transmission target, and is not different in accordance with different content.

The encoding portion 122 uses the key Kw (working key, third key) to encode the key Ks and content information (to be described later) and thereby produce authorization information ECM (entitlement control message, first authorization information). The key Ks and content information enter a state in which decoding does not occur without the key Kw. The key Kw is in the possession of the content protection processing portion 12, it is not different in accordance with different transmission target, and is not different in accordance with different content.

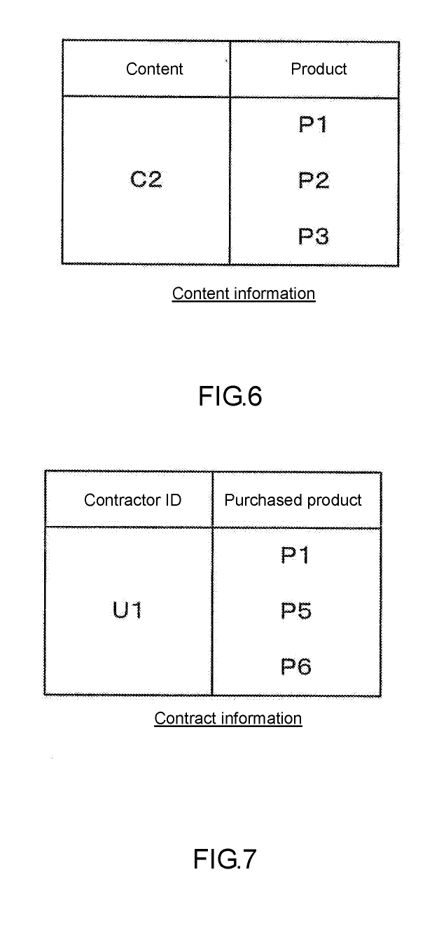

FIG. 6 is a schematic view of content information. The content information is assigned by each content signal and adapted to identify the correlation between the content and a product. For example, as shown in FIG. 6, content information indicates that the content of the assigning target is C2 and it belongs to products P1, P2 and P3 (as shown in FIG. 2).

Referring to FIG. 5, the aforesaid encoded content signals and authorization information ECM are collectively transmitted by the transmitting portion 124 with a play wave. The encoded content signals and authorization information ECM are supplied from a play service provider and transmitted to non-specific targets.

The encoding portion 123 produces authorization information EMM (entitlement management message, second authorization information) to be transmitted to the specific electronic machine 3. More specifically, the encoding portion 123 encodes the key Kw and contract information (to be described later) with the key Km of the contractor of a transmission target and thus produces the authorization information EMM. The key Kw and contract information enter a state in which decoding does not occur without the key Km. Transmitting the authorization information EMM by the communication means not only precludes compression of a play frequency band but also renders it easy to confirm that the authorization information EMM has been received by the specific electronic machine 3. Afterward, the transmitting portion 125 transmits the authorization information EMM to the specific electronic machine 3 by the communication means.

FIG. 7 is a schematic view of the contract information. The contract information is generated from the customer information stored in the customer information memory portion 11. The contract information indicates which product was purchased by a specific contractor. For example, FIG. 7 shows that a contractor with a contractor ID U1 (hereinafter referred to as “contractor U1”) used the electronic machine 3 to purchase products P1, P5, P6 (see FIG. 4.) The contract information and the key Kw are encoded with the inherent key Km1 of contractor U1 (see FIG. 4) and function as the authorization information EMM to be transmitted to the electronic machine 3 of contractor U1. Then, the authorization information EMM is stored in the electronic machine 3.

Since the authorization information EMM does not contain information pertaining to individual content, it may not transmitted together with each content signal. The authorization information EMM may be transmitted from the play device 1 to the electronic machine 3 regularly (for example, once a month) or whenever the contract information changes (for example, when a contractor purchases a new product.)

The play device 1 transmits the encoded content signals and the authorization information ECM by a play wave and transmits the authorization information EMM by the communication means.

Referring to FIG. 3, the distribution device 2 receives encoded content signals from the play wave transmitted by the play device 1 and distributes the encoded content signals to the electronic machine 3 by the communication means. The distribution device 2 comprises a receiving portion (first receiving portion) 21, a processing portion 22, a storing portion 23, a distributing portion 24, and a customer information memory portion 25. The distribution device 2 may be a single device or comprises a plurality of devices. Moreover, constituent elements of the distribution device 2 may provided in the form of hardware. Alternatively, the distribution device 2 may has a built-in processor for executing a distribution program (not shown), whereas at least a portion of the distribution device 2 is effectuated by software.

In the situation where the same dealer provides instant play service and VoD service, at least a portion of the distribution device 2 is disposed in a play radio station or the play device 1, or at least a portion of the play device 1 and the distribution device 2 share the customer information memory portion 25.

The receiving portion 21 receives the encoded content signals and the authorization information ECM from the play wave transmitted by the play device 1.

The processing portion 22 processes the encoded content signals and the authorization information ECM as needed and compresses the content signals. Then, the compressed content signals are stored in the storing portion 23.

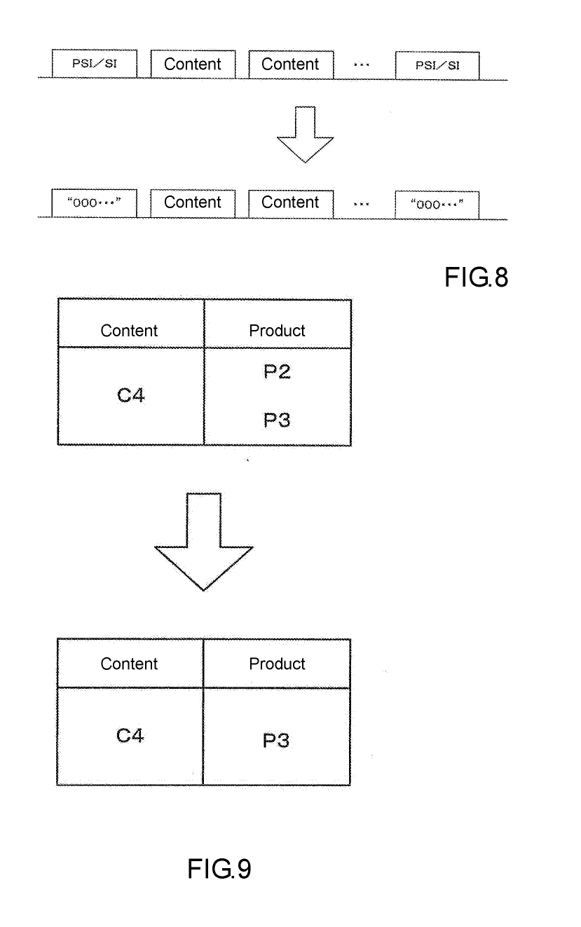

FIG. 8 is a schematic view of operation of the processing portion 22 and shows how to process content signals. As shown in the diagram, the content signals are divided into packets (such as 188 bytes) and then transmitted. Each packet contains not only content-oriented data but also control information for PSI and SI. As mentioned before, control information is not required for distributing content signals by the communication means. The processing portion 22 removes at least a portion of control information, for example, replaces it with 0.

The removal of unnecessary control information is conducive to an increase in the compression rate. It is also feasible that the control information is replaced with any other value conducive to an increase in the compression rate relative to the one when the control information is not replaced with any value. The removal is accompanied by replacement; hence, the format (shape) of content signals, such as the quantity of packets and the bytes of each packet, can be retained.

FIG. 9 is another schematic view of operation of the processing portion 22 and show the operation to the authorization information ECM. The authorization information ECM includes content information (as shown in FIG. 6). The processing portion 22 may corrects the content information.

Referring to FIG. 2, product P2 only allows content C4 to be accessed in an audiovisual manner by instant play service, whereas product P3 allows content C4 to be accessed in an audiovisual manner even by VoD service; meanwhile, when content signals for use with content C4 are transmitted from the play device 1, the assigned content information shows that content C4 is contained in products P2, P3. The processing portion 22 deletes product P2 of products which associated with content C4. In VoD service, only product P3 allows content C4 to be accessed in an audiovisual manner.

In a variant embodiment of the present invention, the processing portion 22 may change the authorization information ECM as needed.

The authorization information ECM can be corrected by the distribution device 2. Both content information for use with instant play service and content information for use with VoD service are useful in generating the authorization information ECM. Even the receiving end of the electronic machine 3 need not discern content information for use with instant play service and content information for use with VoD service.

Referring to FIG. 3, after the processing portion 22 has carried out the aforesaid processing process, the compressed content signals and authorization information ECM are stored in the storing portion 23.

The distributing portion 24 handles the request for content transmission from the electronic machine 3. The request includes information for use in specific content signals and displaying the contractor ID. The distributing portion 24 determines in accordance with the information whether to distribute the requested content signals to the electronic machine 3.

More specifically, the distributing portion 24 specifies, in accordance with the content information included in the authorization information ECM (by content information corrected by the processing portion 22 as shown in FIG. 6), the product associated with the requested content signals. Moreover, both the customer information memory portion 25 and the customer information memory portion 11 of the play device 1 store the customer information (as shown in FIG. 4). The distributing portion 24 determines, in accordance with contractor ID, to distribute when the contractor purchases the specific product.

If the distributing portion 24 determines not to distribute, that is, when the contractor does not purchase any product for use in content requested for audiovisual access, the distributing portion 24 will not distribute the requested content signals to the electronic machine 3. Even if the content signals are distributed to the electronic machine 3, content signals cannot be reproduced even by contract determination of the electronic machine 3 (to be described later). As a result, the burden of distribution can be lessened, if content signals are not distributed from the distributing portion 24 to the electronic machine 3. At this point in time, both information notifying that it cannot be distributed because a related product is not purchased and information about a prompt to purchase the product are distributed to the electronic machine 3.

If the distributing portion 24 determines to distribute, the distributing portion 24 will distribute the requested content signals and authorization information ECM to the electronic machine 3 collectively. The distributing portion 24 can also decompress compressed content signals and then distribute the content signals, but distribution carried out in a compressed state suppresses the amount of communication.

The distribution device 2 distributes the content signals and authorization information ECM to the electronic machine 3 without performing specific protection processes during communication. Thus, the content signals distributed to the electronic machine 3 is just in which unnecessary information is removed from content signals transmitted from the play device 1; hence, the formats of the signals are substantially the same as that of content signals transmitted from the play device 1.

The electronic machine 3 comprises a receiving portion 31, a content protection disabling portion 30 including a determining portion 32, a descrambler(third decoding portion) 33, a decoder 34, a reproduction portion 35, and a communication portion 36. The electronic machine 3 can also consist of a single device or a plurality of devices. Moreover, constituent elements of the electronic machine 3 may provided in the form of hardware. Alternatively, the electronic machine 3 may has a built-in processor for executing a receiving program (not shown), whereas at least a portion of the electronic machine 3 is effectuated by software.

The receiving portion 31 not only receives from a play wave the encoded content signals and the authorization information ECM which are transmitted from the play device 1, but also receives from the communication means the authorization information EMM transmitted from the play device 1.

The determining portion 32 determines, in accordance with the authorization information ECM, EMM, whether to reproduce the received content signals, that is, determines contract determination whether to decode the encoded content signals. When the determining portion 32 determines to reproduce, the determining portion 32 decodes the authorization information ECM, EMM with the key Km of the electronic machine 3, thereby recovering the key Ks and supplying it to the descrambler 33.

The descrambler 33 decodes, with the key Ks, the encoded content signals which are determined to be reproduced, thereby recovering the pre-encoding content signals. More specifically, the descrambler 33 descrambles content signals which effectuate a frequency-changing process.

The decoder 34 converts the recovered content signals into video signals and/or audio signals. The reproduction portion 35 reproduces a display unit for video signals or reproduces a speaker for audio signals.

If only the instant play service is available, the electronic machine 3 which includes just the receiving portion 31, the determining portion 32, the descrambler 33, the decoder 34 and the reproduction portion 35 will suffice. If the VoD service is also required, the electronic machine 3 must be supplemented with the function of communication portion 36. The communication portion 36 is a functional portion which effectuates communication in accordance with a conventional communication protocol. If the electronic machine 3 is preconfigured to be capable of performing the aforesaid function, the electronic machine 3 need not be supplemented.

As instructed by the user, the communication portion 36 requests the distribution device 2 to distribute content signals and then receives from the communication means the encoded content signals and authorization information ECM which are distributed from the distribution device 2. Then, the communication portion 36 decompresses the compressed content signals.

The determining portion 32 performs contract determination on both content signals transmitted from the play device 1 and content signals distributed from the distribution device 2. Similarly, the descrambler 33 descrambles both content signals transmitted from the play device 1 and content signals distributed from the distribution device 2. It is because there is no difference in format between the content signals and authorization information ECM transmitted from the play device 1 and the content signals and authorization information ECM transmitted from the distribution device 2.

Even if using the electronic machine 3, which is designed to receive a play wave transmitted from the play device 1 by using instant play service, when additionally using VoD service, the receiving portion 31, the determining portion 32, the descrambler 33, the decoder 34 and the reproduction portion 35 will not undergo any significant change and thus will still be applicable to VoD service. Moreover, the newly required communication portion 36 can also be available by upgrading the version of the electronic machine 3 or the receiving program as needed.

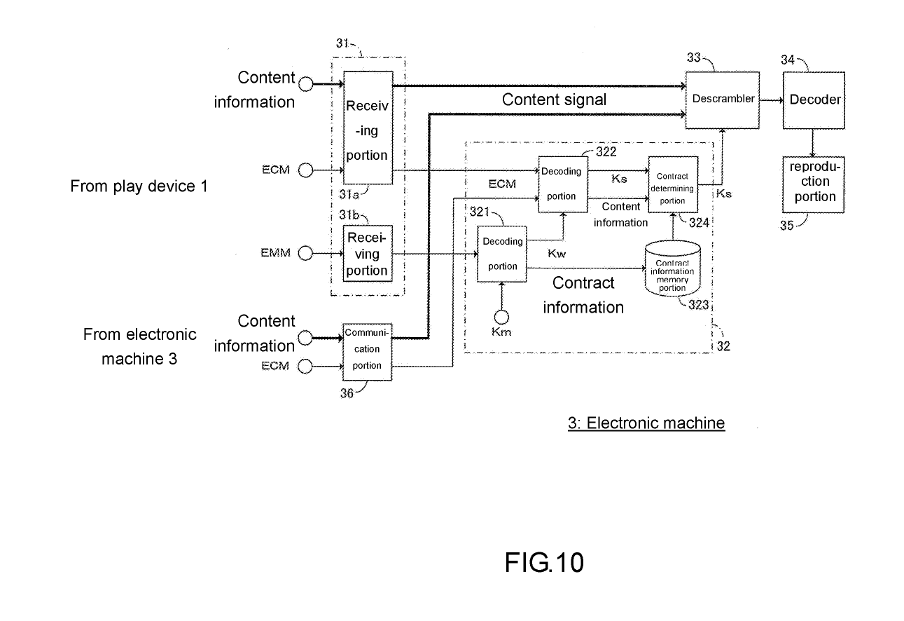

FIG. 10 is a block diagram of the electronic machine 3.

The receiving portion 31 has receiving portions (second receiving portion, third receiving portion) 31a, 31b. The receiving portion 31a receives the encoded content signals and authorization information ECM from the play wave transmitted from the play device 1. The receiving portion 31b receives from the communication means the authorization information EMM transmitted from the play device 1. According to the above description, it is known that the content signals and authorization information ECM received by the receiving portion 31a are identical to the content signals and authorization information ECM received by the receiving portion 21 of the distribution device 2. Furthermore, it is feasible to receive the authorization information EMM and content signals by the communication portion 36.

The determining portion 32 has decoding portions (second decoding portion, third decoding portion) 321, 322, a contract information memory portion 323, and a contract determining portion 324.

The decoding portion 321 decodes the authorization information EMM with the key Km of the electronic machine 3 and recovers the key Kw and contract information. The authorization information EMM generated by the content protection processing portion 12 of the play device 1 is transmitted to the specific electronic machine 3 with the specific key Km. Afterward, since the electronic machine 3 of the transmission target has the same key Km, the authorization information EMM can be decoded. The recovered contract information is stored in the contract information memory portion 323.

The decoding portion 322 uses the recovered key Kw to decode the authorization information ECM and recover the key Ks and content information. The decoding portion 322 is able to recover no matter the authorization information ECM received by the receiving portion 31a from the play wave and the authorization information ECM received by the communication portion 36 from the communication means.

The contract determining portion 324 determines, in accordance with the recovered content information and contract information, whether to decode the received content signals. More specifically, the contract determining portion 324 specifies, in accordance with content information (as shown in FIG. 6), the product to which the received content signals belong. Further, the contract determining portion 324 determines, in accordance with the contract information (as shown in FIG. 7), to decode when the aforesaid specific product is purchased by the contractor.

When it determines to decode, the contract determining portion 324 supplies the key Ks to the descrambler 33. When it determines not to decode, the contract determining portion 324 does not supply the key Ks to the descrambler 33. In this case, the reproduction portion 35 may displays information about distribution failure arising from a lack of purchase of a product and information about a prompt to purchase the product.

As mentioned before, the descrambler 33 uses the recovered key Ks to decode the encoded content signals. The descrambler 33 is able to decode no matter the content signals received by the receiving portion 31a from the play wave and the content signals received by the communication portion 36 from the communication means. The recovered content signals are converted by the decoder 34 into video signals and audio signals, and have their content reproduced by the reproduction portion 35.

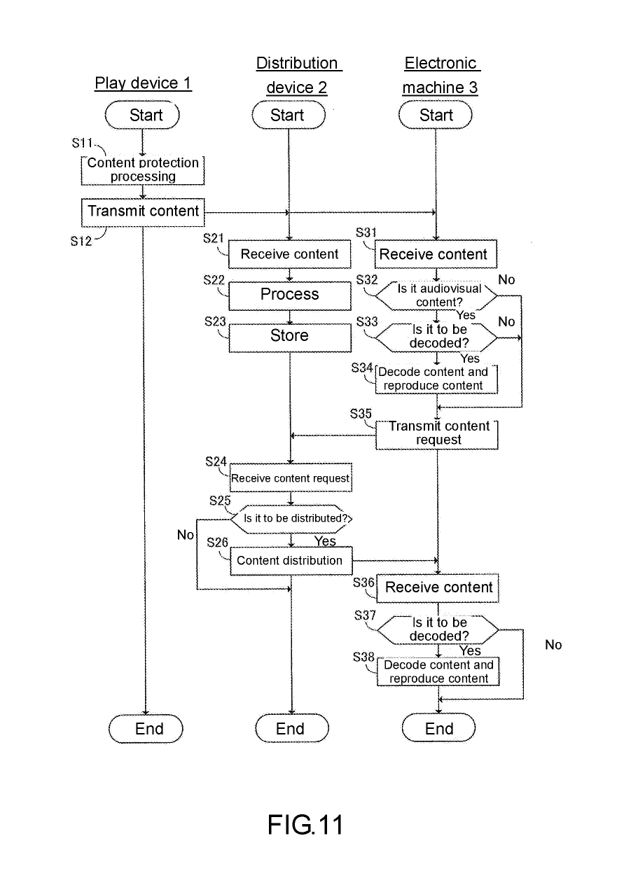

FIG. 11 is a flow chart of operation of the content distribution system. As shown in the diagram, the authorization information EMM including contract information is previously transmitted from the play device 1 to the electronic machine 3, and the contract information is stored in the contract information memory portion 323 in advance.

The content protection processing portion 12 of the play device 1 performs protection processing on content (step S11), and transmits content signals and authorization information ECM as a set by the play wave (step S12).

The receiving portion 21 of the distribution device 2 receives the content signals and authorization information ECM from the play wave (step S21). The processing portion 22 performs necessary processing on the content signals and authorization information ECM, then compresses the content signals (step S22), and stores the compressed content signals in the storing portion 23 (step S23).

The electronic machine 3 can receive the instant play service by receiving the content signals and authorization information ECM from the play wave (step S31). That is, when the user set the electronic machine 3 to gain audiovisual access to play content (“yes” in step S32), the determining portion 32 determines, in accordance with the authorization information EMM and content information, whether to decode the content signals (step S33).

When a contract is made between a user of the electronic machine 3 and an instant play service provider, and the user has purchased a product for gaining audiovisual access to the received content signals, it is determined to decode (“yes” in step S33.) Afterward, the descrambler 33 decodes the encoded content signals, whereas the decoder 34 converts the content signals into video signals and/or audio signals, and the reproduction portion 35 reproduces the content in the form of the video signals and/or audio signals (step S34).

The electronic machine 3 requests the distribution device 2 to distribute the content signals (step S35), so as to receive VoD service.

Upon receiving the content request (step S24), the distributing portion 24 of the distribution device 2 determines whether to distribute content signals to the electronic machine 3 which transmits the content request in accordance with authorization information ECM. When it is determined to distribute (“yes” in step S25), the distributing portion 24 distributes the requested content signals and authorization information ECM as a set to the electronic machine 3 by the communication means (step S26).

The communication portion 36 of the electronic machine 3 receives the content signals and authorization information ECM (step S36). Afterward, the determining portion 32 determines, in accordance with the authorization information EMM and content information, whether to decode the content signals (step S37). In general, the content determined to be distributed by the distributing portion 24 of the distribution device 2 is determined by the determining portion 32 to decode (“yes” in step 37). Afterward, the content is reproduced in the same manner as in step S34 (step S38).

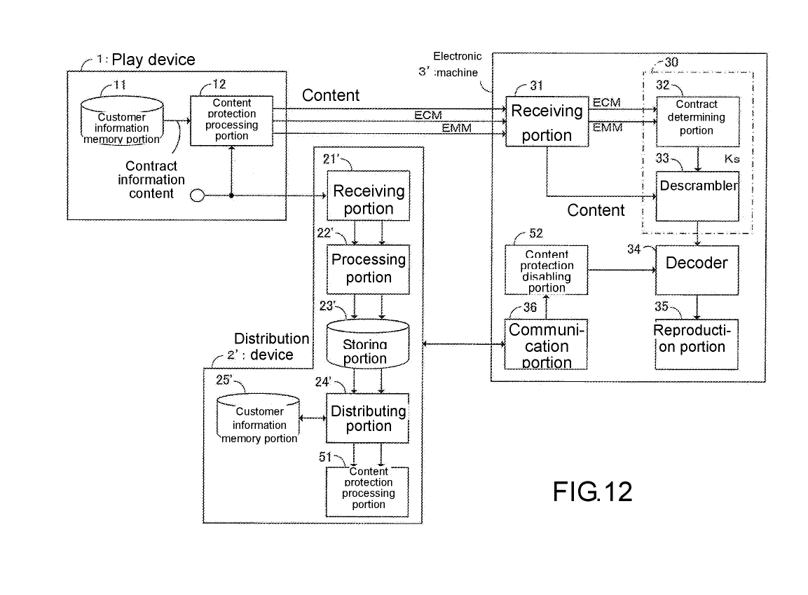

FIG. 12 is a block diagram of devices in the content distribution system according to a comparative example of the present invention. The comparative example does not show that a distribution device 2′ receives the encoded content signals and authorization information ECM from a play wave, but shows that the content is directly fetched and stored in a storing portion 23′. This point is much different from the embodiment illustrated in FIG. 3.

In FIG. 12, when the content signals are distributed from the distribution device 2′ to the electronic machine 3′, the content signals undergo the content protection processing for distributing content signals by the communication means performed by the content protection processing portion 51 disposed in the distribution device 2′ before being distributed to the communication portion 36 of the electronic machine 3′.

In general, play wave-based content protection processing differs from communication means-based content protection processing. As a result, the content protection disabling portion 30 for processing the content signals and authorization information ECM processed by play-based content protection processing is unfitted to process the content signals and authorization information ECM processed by communication means-based content protection processing. Therefore, the electronic machine 3′ is newly equipped with a content protection disabling portion 52 for disabling the communication means-based content protection processing. As a result, the electronic machine 3′ must have therein two content protection disabling portions 30, 52, thus rendering the electronic machine 3 structurally intricate.

In the embodiment illustrated by FIG. 3, it is only necessary to place one content protection disabling portion 30 in the electronic machine 3, and the structure of the electronic machine 3 can be simplified.

One of the advantages of this embodiment over the comparative example of FIG. 12 is as follows: it is easy to add VoD service to conventional instant play service. From the perspective of those dealers who begin to offer VoD service, the only thing they need to do is to introduce the distribution device 2, as the play device 1 can be the same as the one illustrated in FIG. 12. For instance, it is not necessary to change the method of generating protection processing and authorization information ECM of the content signals in the play device 1. Since the distribution device 2 receives the content signals which have undergone protection processing performed by the play device 1, it is not necessary to perform protection processing on the content signals by the distribution device 2 again. Moreover, from the user's perspective, the only thing the user needs to do is to add the communication portion 36, rather than the content protection disabling portion, to every portion of the instant play service.

The first embodiment is characterized in that the distribution device 2 receives the content signals and authorization information ECM from the play wave. Afterward, the distribution device 2 distributes the content signals and authorization information ECM to the electronic machine 3 by the communication means with the same format when transmitted by the play wave. Hence, the content protection disabling portion 30 of the electronic machine 3 is able to perform content protection processing on both the content signals transmitted from the play device 1 by the play wave and the content signals distributed from the distribution device 2 by the communication means, thereby simplifying the structure of the electronic machine 3.

Furthermore, this embodiment is exemplified by the authorization information EMM transmitted by the communication means, but the authorization information EMM may be transmitted by the by the play wave.

### Second Embodiment

In the first embodiment, VoD service involves storing the content signals beforehand and then distributing the content signals at the electronic machine's request and by the communication means. In the second embodiment, a portion of signals which constitute the content signals is distributed by the play means, and a portion of signals which constitute the content signals is distributed by the communication means, instantly and concurrently. The technical features which distinguish the second embodiment from the first embodiment are described below.

In the second embodiment, the content signals consist of a plurality of signals, some of the signals are distributed by the play means, whereas the other signals are distributed by the communication means, thereby distributing more information than it is when the signals are distributed by either the play means or the communication means.

For example, in the content signals, the primary video signals (for example, top-view pictures taken of a sports event) and the primary audio signals (transmitted by the play means) may distributed by the play means, additional video signals (for example, a close-up taken of a specific player during a sports event), and secondary audio signals are distributed by the communication means. In another example, in the content signals, the video signals of 4K resolution are distributed by the play means and then encoded at different levels, the additional information for converting 4K resolution information into 8K resolution is distributed by the communication means. In yet another example, the video signals and the audio signals are distributed by the play means, the related text information, image information, and data are distributed by the communication means. Given the aforesaid examples, persons skilled in the art are able to think of the other applications of the present invention.

In whatever situations, signals which constitute the content signals must be synchronously reproduced. For expediency's sake, among the signals which constitute the content signals, the ones distributed by the play means are known as play distribution signals (first signals), whereas the ones distributed by the communication means are known as communication distribution signal (second signals). The play distribution signals and the communication distribution signals may also include a plurality of signals (for example, audio signals presented in Japanese, and audio signals presented in Chinese.)

The play distribution signals and the communication distribution signals are distributed in the form of a plurality of packets. Each packet shows information as to whether the packet itself is distributed by the play means or by the communication means, for example, included in a title. Moreover, each packet includes an absolute time (prompt time) and a serial number to indicate the time at which the packet shall be reproduced. The electronic machine for receiving the content signals enables the play distribution signals and the communication distribution signals to be synchronously reproduced in accordance with the information.

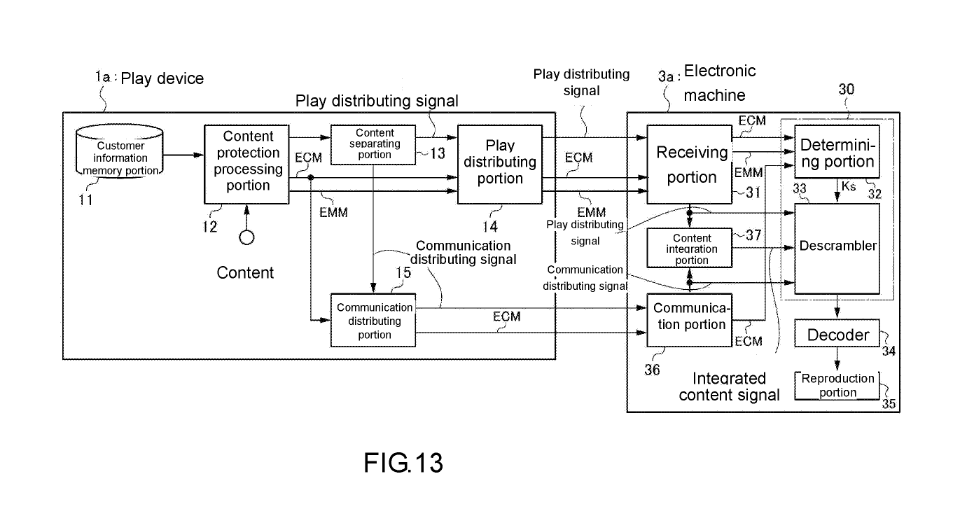

FIG. 13 is a schematic view of the content distribution system according to the second embodiment of the present invention. The content distribution system comprises a play device la and an electronic machine 3a.

In addition to constituent elements shown in FIG. 3, the play device la further comprises a content separating portion 13, a play distributing portion 14, and a communication distributing portion 15. The content separating portion 13 separates an encoded content signals into a play distribution signal and a communication distribution signal in accordance with information contained in the signals which constitute the content signals. The play distributing portion 14 transmits a play distribution signal and authorization information ECM, EMM by a play means. The communication distributing portion 15 transmits communication distribution signals and authorization information ECM by the communication means. The communication distributing portion 15 transmits the communication distribution signals and authorization information ECM to non-specific transmission targets efficiently by multicasting.

Referring to FIG. 5, the content signals are encoded with key Ks in the scrambler 121 of the content protection processing portion 12. Therefore, both a play distribution signal and a communication distribution signal are encoded with the key Ks, in the same manner and in the same format. Moreover, the play distribution signal and the communication distribution signal are not distributed at the request of the electronic machine 3a; instead, the play distribution signal and the communication distribution signal are distributed synchronously and instantly at specific time. Furthermore, it is feasible that not all signals which constitute content signals are encoded.

In addition to constituent elements shown in FIG. 3, the electronic machine 3a further comprises a content integration portion 37. In the content integration portion 37, a play distribution signal is supplied from the receiving portion 31, and a communication distribution signal is supplied from the communication portion 36. The difference in the distribution path between the play distribution signal and the communication distribution signal leads to a delay difference. For example, it is feasible to transmit the play distribution signal first or transmit the communication distribution signal first. Therefore, the content integration portion integrates the play distribution signal and the communication distribution signal synchronously in accordance with information related to display time and contained in the play distribution signal and the communication distribution signal.

In the content protection disabling portion 30, the authorization information ECM is supplied from the receiving portion 31 and the communication portion 36, whereas the signal integrated by the content integration portion 37 is supplied to the play distribution signal from the receiving portion 31 and supplied to the communication distribution signal from the communication portion 36.

The determining portion 32 of the content protection disabling portion 30 determines in accordance with the authorization information ECM whether to decode the content signals. More specifically, the determining portion 32 determines in accordance with the authorization information ECM received from the receiving portion 31 whether to decode the play distribution signal. Moreover, the determining portion 32 determines in accordance with the authorization information ECM received from the communication portion 36 whether to decode the communication distribution signal. Furthermore, the determining portion 32 determines in accordance with the authorization information ECM received from the receiving portion 31 and the authorization information ECM received from the communication portion 36 whether to decode the integrated signal.

Regarding the descrambler 33 of the content protection disabling portion 30, the signal integrated by the content integration portion 37 is supplied to the play distribution signal from the receiving portion 31 and supplied to the communication distribution signal from the communication portion 36. The descrambler 33 descrambles (decodes) one of the signals at the user's request. More correctly, the descrambles 33 descrambles a content element (signal) with a series signal specified as wanted by the user. Therefore, the descrambled content signal is restored to the signal which exists before a frequency change.

The integrated signal, play distribution signal and communication distribution signal are encoded by the content protection processing portion 12 of the play device la and have the same format; hence, the descrambler 33 can descramble any signal. It is not necessary to provide a descrambler for use with the integrated signal, a descrambler for use with the play distribution signal, and a descrambler for use with the communication distribution signal, and thus the signals are jointly descrambled by one said descrambler 33.

The decoder 34 converts the recovered signals into video signals and audio signals. The decoder 34 can also perform in combining the necessary process. Referring to the aforesaid example, the play distribution signal is a video signal with 4K resolution, whereas, when the communication distribution signal is supplemented with information, the decoder 34 generates a video signal with 8K resolution from two signals. Moreover, when a plurality of audio signals is available, the decoder 34 chooses one of them. Alternatively, when a primary video signal and a secondary video signal are available, the decoder 34 can also superimpose the secondary video signal on a part of the primary video signal.

The obtained video signal and audio signal are reproduced by the reproduction portion 35.

Therefore, in the second embodiment, the content signals encoded by the content protection processing portion 12 of the play device la are separated into a play distribution signal and a communication distribution signal and instantly distributed. Since both the play distribution signal and the communication distribution signal are encoded and have the same format, the electronic machine 3a of a receiver can use one descrambler 33 to decode any signal, thereby simplifying the structure of the electronic machine 3.

In this embodiment, free play can also be available so that content signals can be transmitted in an audiovisual manner under no specific contract, in this case, the customer information memory portion 11 is not necessarily in the play device la. The free play is, for example, controlled in accordance with control information ECM contained in content signals. The determining portion 32 disposed in the electronic machine 3a and adapted to receive the control information ECM will function well, provided that it is always determined to reproduce and send the key Ks to the descrambler 33.

At least a portion of the content distribution system in the aforesaid embodiments may be hardware or software. If it is software, a program executable to perform at least a portion of the functionality of the content distribution system can be stored in a record medium, such as a floppy disk or CD-ROM, so as to be read and executed by a computer. The record medium is not restricted to a magnetic disk or a compact disk, which is mountable and demountable, but can also be a fixed record medium, such as a hard disk drive device or memory.

Moreover, the program executable to perform at least a portion of the functionality of the content distribution system can be distributed by a communication network (including a wireless network), such as the Internet. Furthermore, it is also feasible that the program is encoded, modulated, or compressed while being distributed by a wireless network or a wired network, such as the Internet, or stored in a record medium while being distributed.

Given the above description, persons skilled in the art may think of a supplemental effect or various variations of the present invention. However, the present invention is not restricted to the aforesaid embodiments. Various supplements, changes, and partial deletions can be made to the present invention without departing from the scope and conceptual thoughts derived from technical features, and equivalents thereof, recited in the claims.

What is claimed is:

1. A distribution system, comprising: a play device, a distribution device, and an electronic machine to function as a content distribution system, characterized in that:
the electronic machine has an inherent first key;
the play device has a fourth key, a second key, and a third key which correspond to the first key of the electronic machine;
the play device comprising:
a first encoding portion for encoding content signals with the second key to generate encoded content signals, wherein the content signals contain control information required for distribution of content by a play wave;
a second encoding portion for encoding the second key and content information with the third key to generate a first authorization information, wherein the content information is for use in determining whether the content signals can be decoded;
a third encoding portion for encoding the third key and contract information of the electronic machine with the fourth key to generate a second authorization information;
a first transmitting portion for transmitting the encoded content signals and the first authorization information by a play wave; and
a second transmitting portion for transmitting by a communication means the second authorization information to the electronic machine having the first key;
the distribution device comprising:
a first receiving portion for receiving the encoded content signals and the first authorization information from the play device;
a processing portion for replacing at least a portion of the control information in the encoded content signals with a specified value, compressing the encoded content signals which are processed by the replacement and storing in a storing portion, and storing the first authorization information in the storing portion; and
a distributing portion for determining whether to transmit the stored content signals to the electronic machine at the electronic machine's request in accordance with the first authorization information and distributing the stored content signals and the first authorization information to the electronic machine by the communication means when the determination is affirmative;
wherein the specified value is adapted to increase a compression rate or equals 0;
the electronic machine comprising:
a second receiving portion for receiving from a play wave the encoded content signals and the first authorization information which are transmitted from the play device;
a third receiving portion for receiving from the communication means the second authorization information transmitted from the play device;
a first decoding portion for decoding the second authorization information with the first key of the electronic machine and recovering the contract information and the third key;
a second decoding portion for decoding the first authorization information with the recovered third key and recovering the second key and the content information;
a contract determining portion for determining in accordance with the content information and the contract information whether to decode the encoded content signals; and
a third decoding portion for decoding the encoded content signals with the recovered second key when determining to decode the encoded content signals;
and further comprises a communication portion for requesting the distribution device to transmit content signals and receiving from the communication means the encoded content signals and the first authorization information which are transmitted from the distribution device,
wherein the second decoding portion decodes both the first authorization information received by the second receiving portion and the first authorization information received by the communication portion,
wherein the contract determining portion determines whether to decode the content signals received by the second receiving portion and the content signals received by the communication portion,
wherein the third decoding portion decodes both the content signals received by the second receiving portion and the content signals received by the communication portion.

2. A distribution device, comprising:
a receiving portion for receiving from a play wave encoded content signals and authorization information for decoding the encoded content signals;
a processing portion for storing the received content signals and authorization information in a storing portion; and
a distributing portion for distributing the stored content signals and authorization information by a communication means at an electronic machine's request.

3. The distribution device of claim 2, wherein the encoded content signals contain control information required for transmission of the content signals by a play wave, wherein the processing portion replaces at least a portion of the control information from the encoded content signals with a specified value and compresses the replaced encoded content signals.

4. The distribution device of claim 3, wherein the specified value is adapted to increase a compression rate or equals 0.

5. The distribution device of any one of claim 4, wherein the distributing portion determines, in accordance with the authorization information, whether to transmit at the electronic machine's request the requested content signals to the electronic machine and, when the determination is affirmative, distributes the content signals.

6. The distribution device of claim 5, wherein the processing portion corrects the authorization information and stores the corrected authorization information in the storing portion, the distributing portion determines in accordance with the corrected authorization information whether to transmit the requested content signals to the electronic machine.

7. An electronic machine, comprising:
a receiving portion for receiving encoded content signals from a play wave;
a contract determining portion for determining whether to decode the encoded content signals; and
a decoding portion for decoding the encoded content signal when the determination is affirmative;
and further comprises a communication portion for receiving the encoded content signals from a communication means,
wherein the contract determining portion determines whether to decode both the content signals received by the receiving portion and the content signals received by the communication portion,
wherein the decoding portion decodes both the content signals received by the receiving portion and the content signals received by the communication portion.

8. The electronic machine of claim 7, wherein the receiving portion receives from the play wave the encoded content signals and authorization information for decoding the encoded content signals, wherein the communication portion receives from the communication means the encoded content signals and authorization information for decoding the encoded content signals, wherein the contract determining portion determines in accordance with the authorization information whether to decode the encoded content signals.

9. A distribution method, comprising:
a step of receiving from a play wave encoded content signals and authorization information for decoding the encoded content signals;
a step of storing the received content signals and authorization information in a storing portion; and
a step of distributing the stored content signals and authorization information by a communication means at an electronic machine's request.

10. A receiving program, executable by a computer to perform:
a step of receiving encoded content signals from a play wave;
a step of receiving encoded content signals from a communication means;
a step of determining whether to decode content signals received from the play wave or content signals received from the communication means; and
a step of decoding the encoded content signals when the determination is affirmative.

11. A play device, comprising:
a play distributing portion for transmitting, by a play means, a first signal which constitutes a content signal; and
a communication distributing portion for distributing, by a communication means, a second signal which constitutes the content signal,
wherein the first signal and the second signal have the same format and can be decoded by one decoding portion,
wherein the first signal and the second signal are transmitted synchronously.

12. The play device of claim 11, comprising:
an encoding portion for encoding the content signals; and
a content separating portion for separating the encoded content signals into the first signal and the second signal.

13. An electronic machine, comprising:
a receiving portion for receiving from a play means a first signal encoded by an encoding portion and adapted to constitute a content signal;
a communication portion for receiving from a communication means a second signal encoded by the encoding portion, adapted to constitute the content signal, and transmitted in synchrony with the first signal;
a content integration portion for integrating the first signal and the second signal; and
a decoding portion for decoding the encoded first signal, the encoded second signal, and/or the integrated signal.

14. A receiving program, executable by a computer to perform:
a step of receiving from a play means a first signal encoded by an encoding portion and adapted to constitute a content signal;
a step of receiving from a communication means a second signal encoded by the encoding portion, adapted to constitute the content signal, and transmitted in synchrony with the first signal;
a step of integrate the first signal and the second signal; and
a step of decoding any one of the encoded first signal, the encoded second signal and the integrated signal by a decoding means.
